(19) United States
(12) Patent Application Publication
(10) Pub. No.: US 2025/0242288 A1
(43) Pub. Date: Jul. 31, 2025

(54) GAS FILTER SYSTEM

(71) Applicant: MANN+HUMMEL GmbH, Ludwigsburg (DE)

(72) Inventors: Pascal NEEF, Trossingen (DE); Christoph WITTMERS, Bietigheim-Bissingen (DE); Andreas WEBER, Freiberg (DE); Dennis STARK, Mauer (DE); Mario RIEGER, Ludwigsburg (DE); Markus HANSELMANN, Lauffen (DE); Peter PEKNY, Neuenmarkt (DE); Eva HALLBAUER, Himmelkron (DE); Daniel SCHMID, Sachsenheim (DE); Steffen GERLACH, Nufringen (DE); Friedrich KUPFER, Marklkofen (DE); Philipp HETTKAMP, Steinheim (DE); Johannes GRAD, Simbach (DE); Pedro Miguel PEREIRA MADEIRA, Bietigheim-Bissingen (DE); Dieter WEISS, Gefrees (DE)

(21) Appl. No.: 19/083,493

(22) Filed: Mar. 19, 2025

Related U.S. Application Data
(63) Continuation of application No. PCT/EP2023/067126, filed on Jun. 23, 2023.

(30) Foreign Application Priority Data
Sep. 20, 2022 (EP) 22196493.5

(51) Int. Cl. B01D 46/64; B01D 46/00; B01D 46/24; B01D 46/52

(52) U.S. Cl. CPC B01D 46/64; B01D 46/0036; B01D 46/2414; B01D 46/521; B01D 2271/027

(57) ABSTRACT

A gas filter system including a housing, a first filter element having a first filter medium and a second filter element having a second filter medium, the first and second filter elements being arranged inside the housing and the first filter medium and the second filter medium surrounding a common longitudinal axis, wherein a flexible sealing lip protrudes in the axial direction from the first filter medium, wherein the housing has a first sealing surface for sealing abutment against the sealing lip, wherein a rigid sealing rib protrudes from the second filter element, the sealing rib having a second sealing surface for sealing abutment against the sealing lip, wherein the sealing lip is compressed between the first sealing surface and the second sealing surface, and wherein the second sealing surface faces radially outwardly.

### CROSS-REFERENCE TO RELATED APPLICATIONS

This application is a continuation application of international application No. PCT/EP2023/067126 having an international filing date of Jun. 23, 2023, and designating the United States, the international application claiming a priority date of Sep. 20, 2022, based on prior filed European patent application No. 22 196 493.5, the entire contents of the aforesaid international application and the aforesaid European patent application being incorporated herein by reference.

### TECHNICAL FIELD

The present invention refers to a gas filter system including
a housing;
a first filter element having a first filter medium;
a second filter element having a second filter medium;
   the first and second filter elements being arranged inside the housing; the first filter medium and the second filter medium surrounding a common longitudinal axis.

### BACKGROUND

Such a filter system is known from DE 10 2018 215 603 A1.

In some applications, it is required to filter a gas flow with two filter elements. Typically, the gas flows first through a first filter element and then, the prefiltered gas flows through a second filter element. The filter elements may be arranged in a common housing. This kind of filter system is for instance used to filter combustion air for large combustion engines, such as for trucks, construction vehicles or the like. Another application is the filtration of air for fuel cells. For such an application typically one filter element is adapted to filter particles and the other filter element is adapted to adsorb or absorb harmful gases.

DE 10 2018 215 603 A1 discloses a gas filter system with a first filter element which surrounds a second filter element. At a first axial end, open end caps of the two filter elements are associated with an outlet for clean air. At a second axial end, the first (outer) filter element has an open end cap and the second (inner) filter element has a closed end cap. The closed end cap of the inner filter element is arranged to close the opening in the end cap of the outer filter element at the second axial end. The outer filter element may have a support tube with a collar, which extends radially inwardly and covers an opening of the end cap of the outer filter element at the first axial end partially. The collar forms a contact surface for sealing abutment of the open end cap of the inner filter element.

It is an object of the invention to provide a gas filter system with improved sealing between two filter elements, which are adapted for joint use, for example wherein the use of compatible filter elements is required.

This is achieved by a gas filter system according to the invention and use of filter elements according to the invention. Advantageous embodiments of the invention are given in the following description and the accompanying drawings.

### SUMMARY

In accordance with the invention, a gas filter system is provided. The gas filter system includes
a housing;
a first filter element having a first filter medium; and
a second filter element having a second filter medium.

The first and second filter elements are arranged inside the housing. Typically, the first filter medium surrounds the second filter medium. Alternatively, the second filter medium may surround the first filter medium. The second filter element is a filter element according to the invention as described below.

The first filter medium and the second filter medium surround a common longitudinal axis. The filter media may be arranged concentric to the common longitudinal axis. Indications of directions such as radial or axial refer to the longitudinal axis.

Typically, the first filter medium is arranged between a first end cap and a second end cap. Likewise, the second filter medium may be arranged between a third end cap and a fourth end cap. In principle, the first and third end caps are associated with a first axial end; the second and fourth end caps are associated with a second axial end. The first and third end caps are generally open. They may each have a central opening.

During use of the gas filter system, a gas flow is typically first directed from radially outside through the first filter medium of the first filter element and then through the second filter medium of the second filter element. Alternatively, the gas flow may first be directed through the second filter medium and then through the first filter medium.

According to the invention, a flexible sealing lip protrudes, for example in the axial direction, from the first filter medium. For example, the sealing lip is integrally made with the first end cap of the first filter element. This facilitates manufacturing of the first filter element. The sealing lip or the first end cap including the sealing lip may be made of polyurethane, for example polyurethane foam.

The housing has a first sealing surface for sealing abutment against the sealing lip. The first sealing surface may face in the radial direction, for example radially inwardly. The housing, including the first sealing surface, may be made of rigid plastic. The first sealing surface is generally rigid.

Generally, the housing has an inlet for raw gas to be filtered and an outlet for filtered gas. The inlet is in fluid communication with a raw side, which may be located radially outside the outer one of the filter elements. The outlet is in fluid communication with a clean side, which may be located radially inside the inner one of the filter elements. For example, the outlet is arranged at the first axial end, at which the sealing arrangement of the invention is provided.

Typically, the housing includes a first housing part associated with the first end and a second housing part associated with the second end. The inlet may be formed at the first or second housing part. The outlet is typically formed at the first housing part.

Further according to the invention, a rigid sealing rib protrudes from the second filter element. The sealing rib has a second sealing surface for sealing abutment against the sealing lip, wherein the second sealing surface faces radially outwardly. The sealing rib may be made of rigid plastic.

The invention provides that the sealing lip is compressed between the first sealing surface and the second sealing surface. In this way, the first filter element is sealed against the housing. Likewise, the second filter element is sealed against the first filter element. Thus, at the first axial end, a gas flow around the filter elements is prevented. Tightly sealing the sealing lip of the first filter element against the housing and the second filter element requires compression of the sealing lip by the sealing rib of the second filter element. Therefore, it is ensured that only compatible filter elements are used.

The terms “flexible” and “rigid” are to be understood relative to one another. I.e., the sealing lip is softer than the sealing rib or the sealing surface of the housing.

At a second axial end, the filter elements may be sealed against the housing and/or each other. Both the first and the second filter elements are closed at the second end. The second and/or fourth end caps may be monolithically closed. Alternatively, a closing means, such as a closed end face of a support tube, may be sealingly attached to the second and/or fourth end cap.

The sealing lip is compressed in the radial direction (with respect to the longitudinal axis). Radial sealing may be established in this way. Particularly high contact pressures for reliable sealing may be achieved with radial compression, without enforcing high load on the filter media.

The first sealing surface may be formed at an axial collar of the housing. The collar may provide a stiff sealing surface, which may face in the radial direction.

The collar has at least one protrusion protruding beyond the first sealing surface in the radial direction. The protrusion is generally provided at a free end of the collar. To provide a sealing contact of the first sealing surface and the sealing lip, the sealing lip needs to be bent behind the protrusion. Thus, the protrusion ensures that sealing abutment of the sealing lip and the first sealing surface is only established if the sealing rib of the second filter element is present.

The collar may have at least one recess, which stands back behind the first sealing surface in the radial direction. The recess is generally provided at a free end of the collar. The recess may facilitate insertion of the sealing lip. Further, the recess may prevent the use of an unsuitable first filter element.

The housing has a groove for engagement of the sealing lip, the first sealing surface being a (first) radial face of the groove. The groove may provide for the first sealing surface to be geometrically stiffened. Further, inserting the sealing lip into the groove is favorable for mounting of the first filter element.

The filter elements may be cylindrical or conical with a circular or oval cross section. In case of a filter element with circular cross section, the sealing lip, the first sealing surface and the sealing rib are typically circular. Alternatively, they may be provided with a radial indentation or a radial bulge. The latter enforces a defined rotational orientation about the longitudinal axis to be met for mounting of the filter system.

In an embodiment, circumferential interlocking of the sealing rib and the housing is provided. Thus, in the mounted state, the second filter element cannot be rotated around the longitudinal axis relative to the housing.

At least one tooth and at least one notch for mutual engagement may be provided on the sealing rib or the housing, respectively. In this way, it is ensured, that the second filter element is adapted for use with the housing of the filter system. For example, the sealing rib has a first tooth-notch-structure and the housing has a second, corresponding tooth-notch-structure. The tooth-notch-structure of the housing may form a second radial face of the groove. The sealing lip of the filter element abuts the outer walls of the tooth-notch-structure of the housing and the sealing rib respectively. Furthermore, the teeth of the second tooth-notch-structure may provide additional guidance to the sealing lip.

The invention also relates to a filter element, for example for use as a second filter element of a gas filter system according to the invention as described above. The filter element includes a (second) filter medium, which surrounds a longitudinal axis. According to the invention, a rigid sealing rib protrudes from the filter element, the sealing rib having a (second) sealing surface. The sealing rib may protrude from the second filter medium in the radial direction and/or in the axial direction. The sealing rib allows pressing a sealing lip of a (first) filter element against a sealing surface of a housing, in order to seal the first filter element against the housing and the second filter element against the first filter element.

The second sealing surface faces in the radial direction. Radial sealing may be established in this way. Particularly high contact pressures for reliable sealing may be achieved with radial compression, without enforcing load on the filter media.

The sealing rib may be integrally made with a (third) end cap of the (second) filter element. This facilitates manufacturing of the (second) filter element. The sealing rib or the (third) end cap including the sealing rib may be made of rigid plastic. The end cap with the sealing rib may be glued to the (second) filter medium.

The sealing rib is integrally made with a central tube of the filter element. The central tube stiffens the (second) filter element and provides support to the (second) filter medium. The central tube with the sealing rib may be made of rigid plastic. The central tube may be sealed against the (second) filter medium via a (third) end cap of the (second) filter element, which end cap may be made of polyurethane, for example polyurethane foam. This design allows separating rigid (stiff) components (namely the central tube with the sealing rib) and soft components (namely the filter medium and the end cap) during manufacturing.

The central tube may be detachably held at the (second) filter element. Thus, the central tube may be reused upon replacement of the (second) filter element.

Alternatively, the central tube may be permanently affixed to the (second) filter element. For example, the central tube may be glued to the (second) filter element, for instance to a (third) end cap of the (second) filter element.

The sealing rib may have a (second) tooth-notch-structure. This allows for circumferential interlocking with a corresponding (first) tooth-notch-structure of a housing.

The first or the second filter medium, for example the second filter medium of the second filter element, may have gas-adsorbing properties and may contain activated carbon.

The first or the second filter medium, for example the first filter medium of the first filter element, may be made with cellulose.

The filter element which is passed through first is embodied to filter particles and the filter element which is passed through second is embodied to adsorb harmful gases.

The first filter medium and/or the second filter medium may be pleated such that it includes a plurality of pleats arranged in a zig-zag shape. The pleated media is arranged to form a circumferentially closed filter bellows that may have cylindrical or conical shape, for example with a circular or oval cross section.

The invention further relates to the use of a first filter element and/or a second filter element in a gas filter system according to the invention, as described above.

### BRIEF DESCRIPTION OF DRAWINGS

Other advantages and features of the invention will be appreciated from the following description of embodiments of the invention with reference to the accompanying figures of the drawings, which show further details. The individual features, as described above or explained below, may each be implemented individually or implemented together in any useful combination in variants of the invention.

FIG. 1 shows a first embodiment of a gas filter system according to the invention, the gas filter system comprising a first filter element, a second filter element and a housing, in a schematic sectional view.

FIG. 2 shows a first end of the filter system of FIG. 1 in an enlarged view.

FIG. 3 shows a first end of a second embodiment of a filter system according to the invention in a first schematic sectional view with a sectional plane comprising a longitudinal axis.

FIG. 4 shows the first end of the second embodiment in a second schematic sectional view with a different sectional plane comprising the longitudinal axis.

FIG. 5 shows the first end of the of the second embodiment in a third schematic sectional view with a sectional plane perpendicular to the longitudinal axis.

FIG. 6 shows a partially cut, perspective view of the second embodiment.

FIG. 7 shows a first end of a third embodiment of a filter system according to the invention in a first schematic sectional view with a sectional plane comprising a longitudinal axis.

FIG. 8 shows the first end of the third embodiment in a second schematic sectional view with a different sectional plane comprising the longitudinal axis.

FIG. 9 shows a partially cut, perspective view of the third embodiment.

FIG. 10 shows the first end of the third embodiment in a partially mounted state in a schematic sectional view with the sectional plane oriented as in FIG. 7.

### DETAILED DESCRIPTION

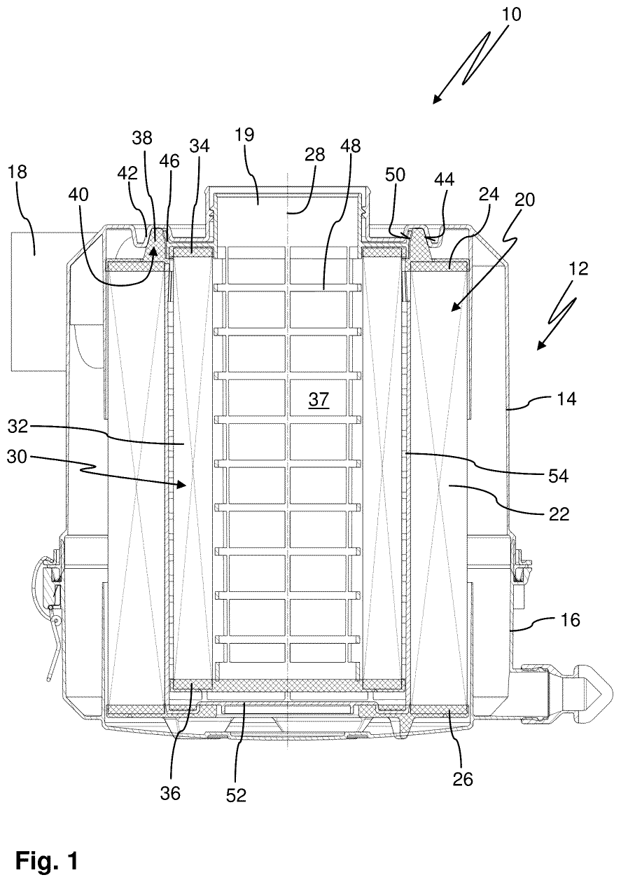

FIG. 1 shows a gas filter system 10. The filter system 10 comprises a housing 12. The housing 12 has a first housing part 14 and a second housing part 16, which are attachable to each other. An inlet 18 allows gas to enter the housing 12. Here the inlet 18 is formed at the first housing part 14. An outlet 19 for filtered gas is also formed at the first housing part 14. The housing parts 14, 16 may be made from metal and/or rigid plastic.

The filter system 10 further comprises a first filter element 20. The first filter element 20 comprises a first filter medium 22. The first filter medium 22 is contained between a first end cap 24 and a second end cap 26. The first end cap 24 has a central opening. The first filter medium 22 surrounds a longitudinal axis 28 in a circular manner. The first filter medium 22 may be made from pleated cellulose paper.

The filter system 10 further comprises a second filter element 30. The second filter element 30 comprises a second filter medium 32. The second filter medium 32 is contained between a third end cap 34 and a fourth end cap 36. The third end cap 34 has a central opening. The second filter medium 32 also surrounds the longitudinal axis 28 in a circular manner. The second filter medium 32 may contain activated carbon in order to achieve gas-adsorbing properties.

In the depicted embodiment, the second filter element 30 is arranged inside the first filter element 20. Both filter elements 20, 30 are arranged inside the housing 12. Here, the first filter medium 22 and the second filter medium 32 are concentric to one another and to the longitudinal axis 28.

At a first axial end, the first and second filter elements 20, 30 are sealed against each other and the housing 12. The outlet 19 is in fluid communication with a clean side 37 within the inner second filter element 30.

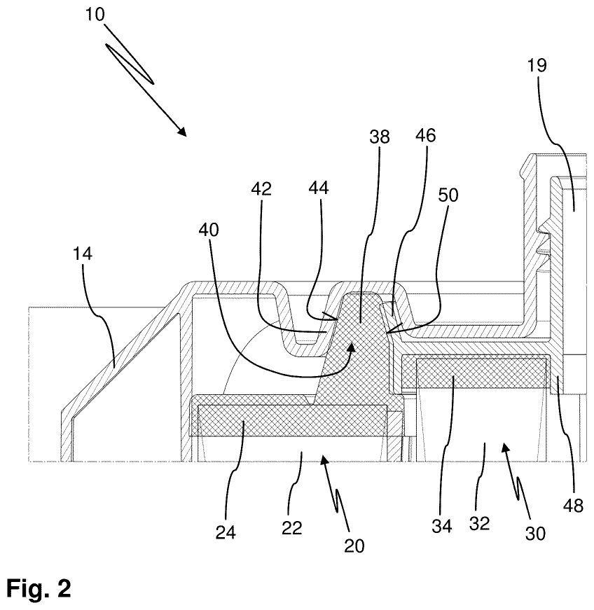

A sealing lip 38 protrudes, here in the axial direction, from the first filter element 20, see also FIG. 2. The sealing lip 38 is monolothic with the first end cap 24. Here, the first end cap 24 and the sealing lip 38 are integrally made from polyurethane foam. The sealing lip 38 is flexible so that the sealing lip 38 is compressed in order to seal against sealing surfaces, as described further below.

The sealing lip 38 is engaged in an annular groove 40 of the housing 12. An axial collar 42 may form an outside wall of the groove 40. A first radial face, here the outside face, of the groove 40, which face is part of the collar 42, forms a first sealing surface 44. In the depicted embodiment, the first sealing surface 44 faces radially inwardly.

A sealing rib 46 protrudes from the second filter element 30. Here, the sealing rib 46 extends beyond the second filter medium 32 in the radial direction towards the outside and in the axial direction.

In the depicted embodiment, the sealing rib 46 is monolithic with a central tube 48 of the second filter element 30. Here, the central tube 48 and the sealing rib 46 are integrally made from rigid plastic. The central tube 48 may be detachably or permanently held at the second filter medium 32. The third end cap 34 of the second filter element 30 provides sealing of the second filter medium 32 against the central tube 48 with the sealing rib 46. The third end cap 34 may be made from polyurethane foam. Alternatively, the ring-shaped part connecting the central tube 48 with the rib 46 may replace the third end cap 34 and the second filter medium 32 may be glued to this ring-shaped part.

A second sealing surface 50 is formed at the sealing rib 46. The second sealing surface 50 faces radially outwardly.

The sealing rib 46 is also engaged in the groove 40 of the housing 12. The sealing lip 38 is compressed, here in the radial direction, between the first sealing surface 44 of the housing 12 and the second sealing surface 50 of the second filter element 30. Thus, sealing between the first filter element 20 and the first housing part 14 of the housing 12, as well as between the first filter element 20 and the second filter element 30 is obtained with only one sealing lip.

The first housing part 14 of the housing 12 and the sealing rib 46 are stiff as compared to the sealing lip 38. I.e., the (here radial) deformation of the housing 12 at the first sealing surface 44 or of the second filter element 30 at the second sealing surface 50 is smaller, for example by a factor of at least two or five, as the radial compression of the sealing lip 38.

The sealing lip 38, the first sealing surface 44 and the sealing rib 46 are generally circular. Optionally, they may be provided with a radial indentation or a radial bulge interfering with one another in order to make sure that the first and second filter elements 20, 30 may be installed in the housing 12 in a defined rotational position.

At a second axial end, the first and second filter elements 20, 30 may be closed. In the depicted embodiment, the fourth end cap 36 of the second filter element 30 is a monolithic closed end cap, which may be made of polyurethane foam. The first filter element 20 is closed at the second end cap 26 by an end face 52 of a support tube 54. The support tube 54 may be made of rigid plastic and may be partially embedded in the second end cap 26, which may be made of polyurethane foam.

A second embodiment of the gas filter system 10′, which is partially depicted in FIGS. 3, 4, 5 and 6, corresponds substantially to the first embodiment of the gas filter system 10, cf. FIGS. 1 and 2 and the description above. In the second embodiment, circumferential interlocking between the second filter element 30 and the housing 12, here the first housing part 14, is provided.

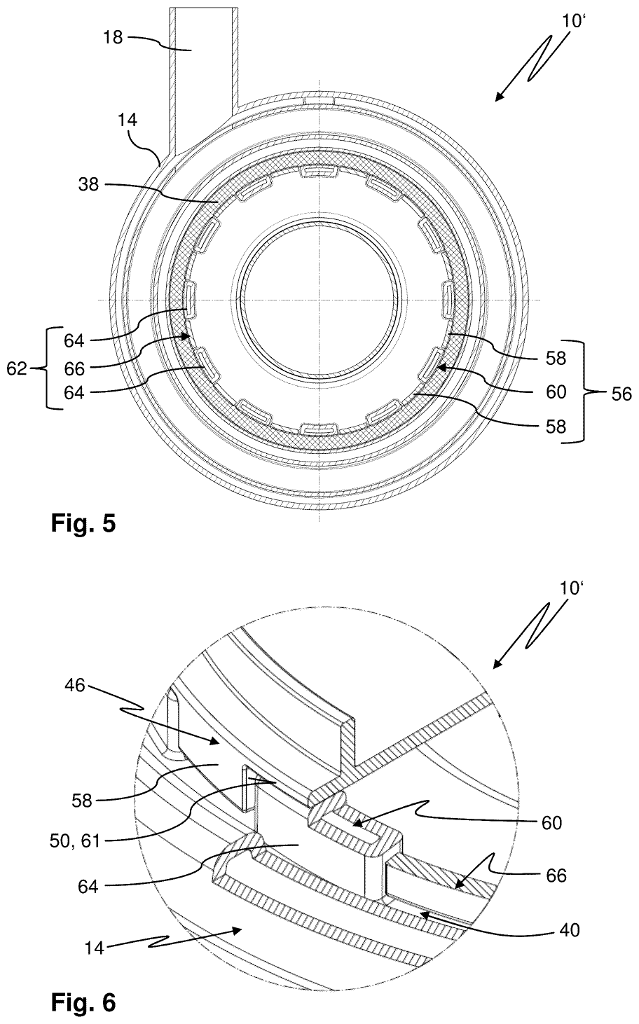

The sealing rib 46 has a first tooth-notch-structure 56 (see for example FIG. 5) comprising first teeth 58 and first notches 60 arranged between the first teeth 58. The first teeth 58 extend axially from an annular base section 61 of the second sealing surface 50 (see for example FIG. 6).

A second tooth-notch-structure 62 of the first housing part 14 forms a second radial face of the groove 40 (see for example FIGS. 5 and 6). The second tooth-notch-structure 62 has second teeth 64 and second notches 66 arranged between the second teeth 64. The sealing lip 38 is received in the groove 40 between the first sealing surface 44 and the second tooth-notch-structure 62 (see for example FIG. 3).

The first and second tooth-notch-structures 56, 62 are adapted for mutual engagement of their teeth 58, 64 and notches 60, 66. Rotation of the second filter element 30 about the longitudinal axis 28 relative to the housing 12 is thereby prevented.

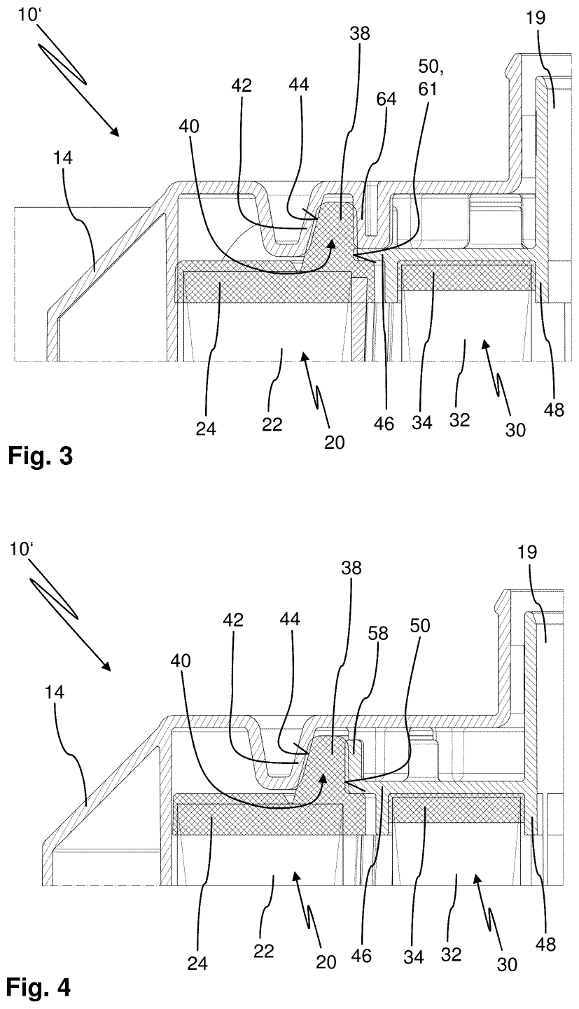

The base section 61 of the second sealing surface 50 radially presses against the sealing lip 38 continuously in circumferential direction (cf. FIG. 3). In the area of the second notches 66, the first teeth 58 of the sealing rib 46 also press radially against the sealing lip 38 (cf. FIG. 4). Consequently, the sealing lip 38 is sealingly clamped between the first sealing surface 44 and the second sealing surface 50.

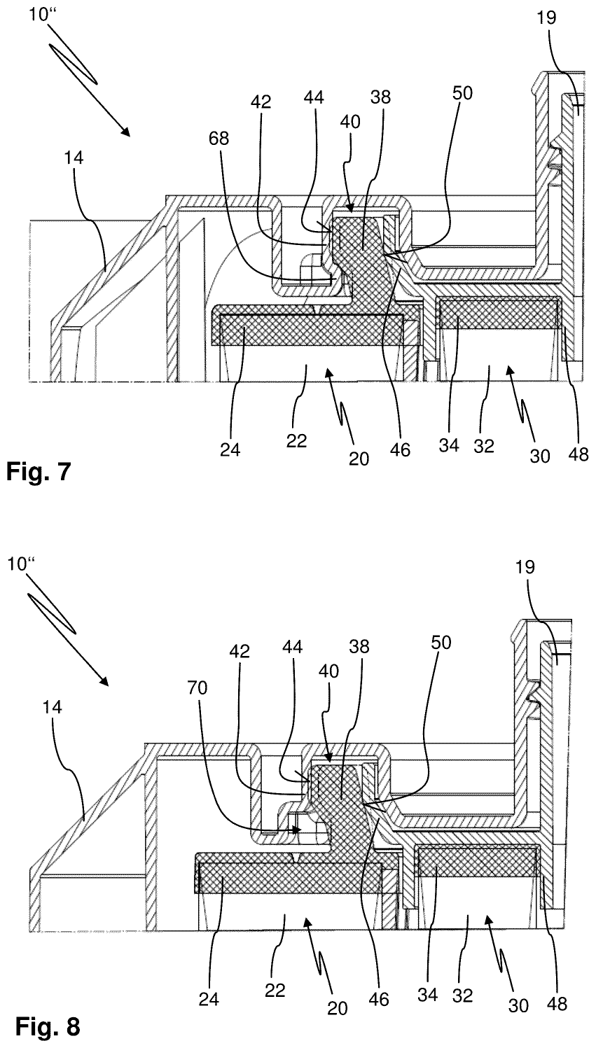

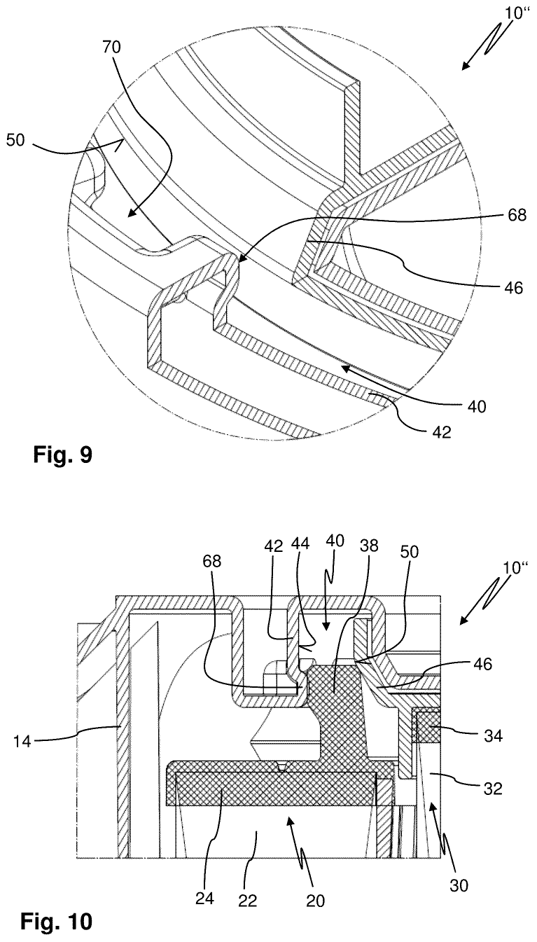

A third embodiment of the gas filter system 10″, which is partially depicted in FIGS. 7, 8, and 9, corresponds substantially to the first embodiment of the gas filter system 10, cf. FIGS. 1 and 2 and the description above. Note that circumferential interlocking as in the second embodiment might also be provided with the third embodiment (not depicted). In the third embodiment, the collar 42, on which the first sealing surface 44 is provided, has radial protrusions 68 and radial recesses 70. The recesses 70 stay back behind the first sealing surface 44 and shorten the axial extension of the first sealing surface 44.

The protrusions 68 extend beyond the first sealing surface 44 towards the sealing lip 38. For sealing abutment of the sealing lip 38 against the first sealing surface 44, the sealing rib 46 deforms the sealing lip 38, such that the sealing lip 38 is bent towards the first sealing surface 44, see FIGS. 7 and 8. Without the deformation enforced on the sealing lip 44 by the sealing rib 46, sealing abutment of the sealing lip 44 against the first sealing surface 44 would not be possible.

FIG. 10 shows the gas filter system 10″ during mounting of the first filter element 20. The sealing lip 38 is in an undeformed state. For insertion of the sealing lip 38 into the groove 40, the sealing lip 38 has to be compressed between the protrusions 68 and the sealing rib 46. Upon further insertion, the sealing lip 38 is deflected towards the first sealing surface 44 by the sealing rib 46 with the second sealing surface 50, such that sealing abutment is achieved.

### REFERENCE NUMBERS

Gas filter system 10; 10′; 10″
Housing 12
First housing part 14
Second housing part 16
Inlet 18
Outlet 19
First filter element 20
First filter medium 22
First end cap 24
Second end cap 26
Longitudinal axis 28
Second filter element 30
Second filter medium 32
Third end cap 34
Fourth end cap 36
Clean side 37
Sealing lip 38
Groove 40
Collar 42
First sealing surface 44
Sealing rib 46
Central tube 48
Second sealing surface 50
End face 52
Support tube 54
First tooth-notch-structure 56
First teeth 58
First notches 60
Base section 61
Second tooth-notch-structure 62
Second teeth 64
Second notches 66
Protrusions 68
Recesses 70

1. A gas filter system comprising
a housing;
a first filter element having a first filter medium;
a second filter element having a second filter medium;
the first filter element and the second filter element being arranged inside the housing;
the first filter medium and the second filter medium surrounding a common longitudinal axis;
wherein a flexible sealing lip protrudes in an axial direction from the first filter medium;
wherein the housing has a first sealing surface for sealing abutment against the sealing lip;
wherein a rigid sealing rib protrudes from the second filter element, the sealing rib having a second sealing surface for sealing abutment against the sealing lip;
wherein the sealing lip is compressed between the first sealing surface and the second sealing surface; and
wherein the second sealing surface faces radially outwardly.

2. The gas filter system according to claim 1, wherein the sealing lip is integrally made with a first end cap of the first filter element.

3. The gas filter system according to claim 1, wherein the sealing lip is compressed in a radial direction.

4. The gas filter system according to claim 1, wherein the first sealing surface is formed at an axial collar of the housing.

5. The gas filter system according to claim 4, wherein the collar has at least one protrusion protruding beyond the first sealing surface in a radial direction.

6. The gas filter system according to claim 4, wherein the collar has at least one recess, which stands back behind the first sealing surface in a radial direction.

7. The gas filter system according to claim 4, wherein the housing has a groove for engagement of the sealing lip, the first sealing surface being a radial face of the groove.

8. The gas filter system according to claim 1, wherein circumferential interlocking of the sealing rib and the housing is provided.

9. The gas filter system according to claim 8, wherein at least one tooth and at least one notch for mutual engagement are provided on the sealing rib or the housing, respectively.

10. A filter element for use as the second filter element of the gas filter system according to claim 1, the second filter element comprising the second filter medium, which surrounds the longitudinal axis;
wherein the rigid sealing rib protrudes from the second filter element, the sealing rib having the sealing surface that faces radially outwardly.

11. The filter element according to claim 10, wherein the sealing rib is integrally made with an end cap of the second filter element.

12. The filter element according to claim 10, wherein the sealing rib is integrally made with a central tube of the second filter element.

13. The filter element according to claim 12, wherein the central tube is detachably held at the second filter element.

14. The filter element according to claim 12, wherein the central tube is permanently affixed to the second filter element.

15. The filter element according to claim 10, wherein the sealing rib has a tooth-notch-structure.

16. Use of the first filter element and/or the second filter element in the gas filter system according to claim 1.
